(19) United States
(12) Patent Application Publication
(10) Pub. No.: US 2003/0218331 A1
(43) Pub. Date: Nov. 27, 2003

(54) Game ticket assembly

(76) Inventor: Alan Yesser, Harrisburg, PA (US)

Correspondence Address: Jeffrey S. Habib, Esq., Thomas Hooker, P.C., 100 Chestnut Street, Suite 304, Harrisburg, PA, 17101, US

(21) Appl. No.: 10/154,574

(22) Filed: May 24, 2002

(51) Int. Cl. B42D 15/00

(52) U.S. Cl. 283/106

(57) ABSTRACT

A game ticket assembly includes a number of game tickets for playing games of chance. The game ticket assembly is formed from a continuous strip of material, with the game tickets spaced along the length of the strip. The material is folded and the tickets form a stack of game tickets. A fold joins the edges of the top and bottom game tickets on one side of the stack. A flap extends along the other side of the stack from the bottom game ticket and adheres to the top game ticket.

### FIELD OF THE INVENTION

The invention relates generally to game tickets for playing games of chance, and particularly to a game ticket assembly containing a number of game tickets.

### BACKGROUND OF THE INVENTION

Many commercial and non-commercial establishments operate games of chance. The games provide entertainment for patrons and are an important source of revenue. Patrons play for a chance of winning a substantial cash prize with a relatively small cash purchase.

Lottery-type games have become especially popular. The establishment buys a set of lottery tickets for resale to its patrons. Game tickets are typically sold as packs of multiple tickets, each pack including three to five tickets. This provides a purchaser with several opportunities to win with each purchase. The game tickets include game symbols that determine winning or losing tickets.

Winning game tickets are redeemed for a prize or qualify the purchaser for another round of game play. The payouts in each set of tickets are determined in advance and ensure that the establishment will make a profit from the ticket sales. Ticket sales, game payouts and game play are usually regulated by state gaming agencies.

A conventional ticket pack is an assembly formed from a number of separate game tickets. Each game ticket is printed on a separate strip of paper. Thee paper strips are placed together in a stack and a side of the stack is double-folded to conceal the game symbols. A paper band tightly surrounds the double-fold and prevents the ticket stack from unfolding.

A set of banded ticket assemblies are placed in a jar or other receptacle. The game tickets have serial numbers printed on them that identify the tickets as part of the set. Purchasers randomly select ticket assemblies from the jar until the entire set of tickets is sold. The purchaser breaks the band with his or her thumb and separates the tickets to determine winners or losers. Many game players enjoy “flicking” the folded tickets to break the band, and become adept at breaking the band and spreading the tickets apart in a smooth, continuous motion.

Although banded ticket assemblies are popular, they do have shortcomings. Sometimes too few or too many game tickets are folded together, or game tickets with the wrong serial number are intermixed in the ticket stack. In one type of banded ticket assembly, the band is stapled together. The staples often tangle the ticket assemblies together in the jar, and the sharp staple points are a nuisance when breaking the band. Other known banded game ticket assemblies glue the band together. This requires specialized machinery.

Other known game tickets include scratch-off coatings or break-open windows that conceal the game symbols. These types of game tickets, however, can be expensive to manufacture and lack the tactile feedback of flicking open the game tickets with the thumb that many players enjoy.

Thus, there is a need for an improved game ticket assembly. The game ticket assembly should be readily manufactured at low cost using widely available equipment. Handling separate, individual game tickets to form the ticket assemblies should be eliminated. The risk of forming game ticket assemblies containing tickets having different serial numbers should be reduced. The tickets should be visually appealing and provide the tactile feedback of flicking the game tickets open with the thumb.

### SUMMARY OF THE INVENTION

The invention is an improved game ticket assembly that can be readily manufactured at low cost with widely available equipment. The improved game ticket assembly does not require handling separate game tickets to form the ticket assembly, and the risk of producing game ticket assembles containing tickets having different serial numbers is reduced. Furthermore, the tickets can be visually appealing and opened with the thumb for desirable tactile feedback. The tickets do not require scratch-off coatings or break-open windows, although these can be provided if additional concealment of the game symbols is desired.

A game ticket assembly in accordance with the present invention includes a number of game tickets, preferably three to five game tickets. The game tickets are arranged in a stack and include a top game ticket on top of the stack and a bottom game ticket on the bottom of the stack. A breakable or releasable connection joins the top and bottom game tickets to retain the game tickets in their stacked configuration until a purchaser breaks the connection.

The game tickets are formed from a continuous length of material that includes a number of folds spaced along the material. Each fold joins respective pairs of game tickets. The game tickets rotate or displace about the folds from a folded position on the stack to an unfolded position when the connection is broken for game play.

The game symbols and serial numbers can be printed on the material strip before folding the game tickets to form the ticket stack. A number of strips can be provided as a large sheet and printed together for efficient high volume production. The printed sheet can then be cut into separate strips.

In a preferred embodiment of the present invention a flap extends from the bottom game ticket along one side of the stack and overlaps the game ticket on top of the stack. The flap adheres to the top game ticket and connects the top and bottom game tickets. The flap can be opened with the thumb to unfold the game tickets from the stack.

A fold joins the edges of the top and bottom game tickets. The fold extends along the other side of the stack and cooperates with the flap to contain the edges of the game tickets in the stack. Glue lines formed on the tickets adhere the tickets together in the stack and assist in keeping the game symbols concealed prior to opening the flap.

In yet other embodiments of the present invention the flap can be eliminated. The glue lines adhering the tickets together can connect the top and bottom game tickets. The game ticket assembly can be provided with a pull tab to facilitate unfolding the game tickets. Alternatively, a band can surround the stack and maintain the game tickets in their stacked arrangement.

The improved game ticket assembly has a number of advantages over conventional ticket assemblies. The game tickets are formed from a continuous strip of material. Handling and assembling separate, individual game tickets is eliminated. The game tickets can be printed as a unit using conventional printing machines, and the risk of assembling game tickets with mismatched serial numbers is substantially reduced.

Game symbols can be concealed in the interior of the stack, so scratch-off coatings or break-open windows are not necessary. These concealment devices, however, can be incorporated into the improved game ticket assemblies of the present invention.

Other objects and features of the invention will become apparent as the description proceeds, especially when taken in conjunction with the accompanying drawings illustrating game ticket assemblies of the present invention, of which there are three sheets of eight embodiments.

### BRIEF DESCRIPTION OF THE DRAWINGS

FIG. 1 is a side view of a first embodiment game ticket assembly in accordance with the present invention;

FIG. 2 is a top view of the game ticket assembly shown in FIG. 1;

FIG. 3 is a bottom view of the game ticket assembly shown in FIG. 1;

FIG. 4 is a front view of the material strip forming the game ticket assembly shown in FIG. 1;

FIG. 5 is a back view of the material strip shown in FIG. 4;

FIG. 6 is a view similar to FIG. 1 of a second embodiment game ticket assembly in accordance with the present invention;

FIG. 7 is a schematic top view of the material strip forming the game ticket assembly shown in FIG. 6 and illustrating folding of the material strip;

FIG. 8 is a view similar to FIG. 1 of a third embodiment game ticket assembly in accordance with the present invention;

FIG. 9 is a schematic top view of the material strip forming the game ticket assembly shown in FIG. 8 and illustrating folding of the material strip;

FIG. 10 is a view similar to FIG. 1 of a fourth embodiment game ticket assembly in accordance with the present invention;

FIG. 11 is a view similar to FIG. 1 of a fifth embodiment game ticket assembly in accordance with the present invention;

FIG. 12 is a view similar to FIG. 1 of a sixth embodiment game ticket assembly in accordance with the present invention;

FIG. 13 is a front view of a material strip for forming a seventh embodiment game ticket assembly in accordance with the present invention;

FIG. 14 is a view similar to FIG. 13 of a material strip for forming an eighth embodiment game ticket assembly in accordance with the present invention; and

FIG. 15 is a side sectional view of the material strip shown in FIG. 14 taken along lines 15-15 of FIG. 14.

### DESCRIPTION OF THE PREFERRED EMBODIMENTS

FIGS. 1-3 illustrate a first embodiment game ticket assembly 10 in accordance with the present invention. The assembly 10 includes a number of game tickets arranged in a stack. The game tickets include a bottom game ticket 12 on the bottom of the stack, a top game ticket 14 on top of the stack, and an intermediate game ticket 16 between the bottom and top game tickets 12 and 14. Game symbols (described below) are printed on the tickets to define winning and losing tickets.

Attached to the bottom game ticket 12 is a flap 18 that extends along one side of the stack and overlaps the top of the stack. The flap overlap adheres to the top game ticket 14. The flap forms a connection between the top and bottom game tickets 12, 14 that retains the game tickets 12, 14, 16 in their stacked arrangement.

The game ticket assembly 10 is formed from a continuous length or strip of material 20, preferably card stock. See FIGS. 4 and 5. The material strip 20 has a front face 22 and a back face 24. A flap section 26 is adjacent one end of the strip 20 and a game ticket section 28 forms the remainder of the strip. A first fold represented by a fold line 30 joins the flap section 26 and the game ticket section 28. The game ticket section includes the game tickets 12, 14 and 16. The tickets are spaced apart from each other along the length of the strip, with the bottom game ticket 12 between the adjacent flap section 26 and the top game ticket 14. A number of second folds represented by fold lines 32 are located between adjacent pairs of game tickets and connect the edges of the adjacent tickets. Fold line 32a is between game tickets 12 and 14 and fold line 32b is between game tickets 14 and 16.

A pair of glue lines 34 are on the front face 22 of the strip 20 and extend the entire length of the strip 20. The glue lines 34 run along the top and bottom edges of the strip. The glue lines adhere the flap 18 to the game ticket 14 and adhere the tickets 12, 14, 16 to each other in the stack as will be described below.

Each game ticket 12, 14, 16 includes a game symbol area 36 on the front face of the strip 20. A game symbol 38 is printed in each symbol area 36 and determines whether the ticket is a winner and the ultimate award payout. On the back face of the strip 20 each ticket includes a label area 40 for printing a label 42 and a serial number area 44 for printing a serial number 46.

The illustrated serial number 46 is a numeric identifier, but the term “serial number” should be understood to encompass any indicia intended to uniquely identify or track game ticket assemblies 10. Printing and recording serial numbers is typically regulated by state gaming agencies.

The game ticket assembly 10 is manufactured by printing the game symbols 38 on the front of the strip 20 and the serial numbers 46 and labels 44 on the back of the strip using a conventional printing press. The printing of the game tickets is preferably made on large sheets of card stock to efficiently print a large number of game tickets in a production run. The preprinted sheets are then cut into the strips 20. The glue lines 34 can be applied to the strips 20 prior to cutting the strips with conventional glue application technology and glues.

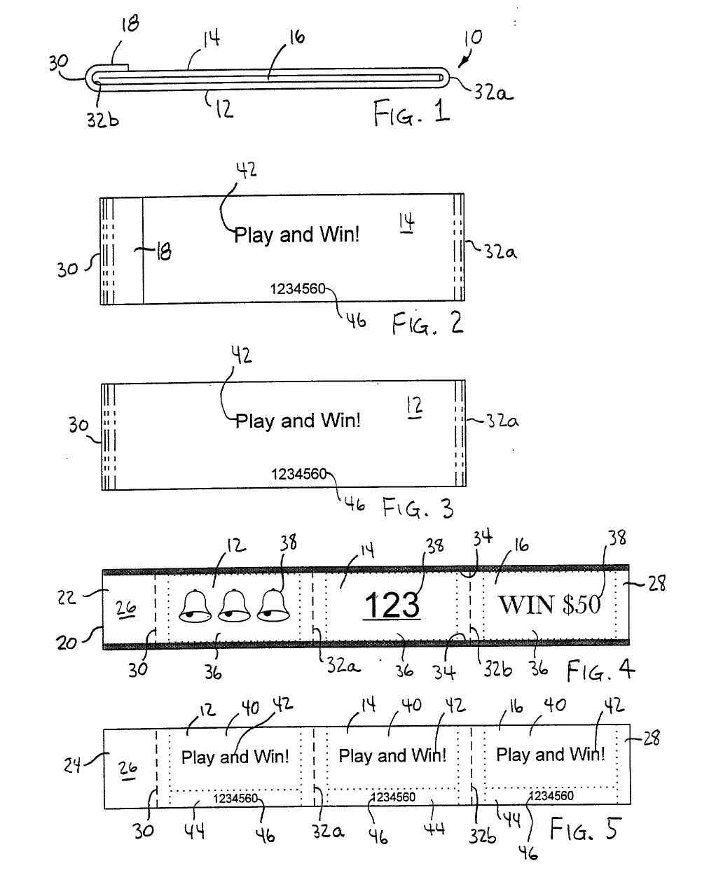

The strip 20, having the game tickets printed on it, is folded along the fold lines 32 to form the stack of game tickets. The game ticket 16 is folded over the game ticket 14 and the game ticket 14 is then folded over the game ticket 12 to form the interfolded game tickets shown in FIG. 1. The glue lines 34 adhere facing tickets together along the top and bottom edges of the tickets. The glue lines adhere either to the bottom face or the glue lines on the top face of the facing game ticket. After the stack is formed, the flap 18 is folded upward along the fold line 32 to attach the flap 18 to the top of the stack. The glue on the flap 18 adheres to the outer face of the top game ticket 14. The flap 30 is on one side of the stack and the flap 32a is on the other side of the stack (see FIGS. 2 and 3).

As best seen in FIG. 1, the folds 30 and 32 will have different radii of curvature when the game ticket assembly is formed. For example, the fold 32a has a relatively large radius of curvature joining game tickets 12, 14 to accommodate the game ticket 16 between them. On the other hand, the fold 32a is a sharp crease joining adjacent game tickets 14 and 16. The spacing between the game tickets 12, 14, and 16 can vary to accommodate the variable radii of curvature of the folds 32.

The game ticket assembly 10 is formed with the back face 24 of the top and bottom game tickets 14, 12 forming the outer faces of the stack of game tickets (see FIGS. 2 and 3). This displays game labels 42 on the top and bottom faces of the assembly (see FIGS. 2 and 3). The labels preferably include aesthetically pleasing artwork or graphics to promote game play and player interest. The labels form a large portion of the exposed surfaces of the game ticket assembly, enhancing the ability of the graphics to attract players. Graphics can also be placed on the exposed side of the flap 18.

The game ticket assembly 10 includes a number of security features that reduce the risk of fraudulent redemption and increase the confidence of purchasers in the integrity of the game play.

Firstly, the fold 32a joining the bottom and top game tickets 12 and 14 extends along the side of the stack opposite the flap 18. The fold 32a and the flap 18 cooperate to hold the ends of the game tickets together in the stack and resist riffling of the game tickets. Secondly, the top faces of the game tickets 12, 14, 16 and the game symbols printed on them are concealed from view within the ticket stack.

Thirdly, the game tickets 12, 14, 16 adhere to one another along the top and bottom edges of the tickets. Adhesion along the top and bottom edges resists attempts to separate and view the front faces of the tickets by compressing the sides of the stack. The glue forming the glue lines 34 preferably adheres readily to itself or the card stock to form a glue joint but does not readily re-adhere when the glue joint is broken. This prevents the game stack from being opened or compressed, resealed, and passed off as an unopened game ticket assembly.

Lastly, the game labels 42 and the serial numbers 46 preferably include anti-counterfeiting measures that are readily observable. The game stack assembly 10 displays the labels and serial numbers on the top and bottom of the stack and players can readily verify the integrity of the anti-counterfeiting measures prior to opening the game tickets.

In play, a set of game ticket assemblies 10 is placed in a jar or other receptacle. A purchaser pulls a game ticket assembly 10 at random from the receptacle. The flap 18 can be peeled away or “flicked” with the thumb to break the connection between the top and bottom game tickets. The game tickets are then rotatable about the folds from a folded position on the stack to an unfolded position for game play. The ability to flick the open the game ticket assembly preserves a feature that many players find appealing in conventional game ticket assemblies. As described, the glue does not permit the game ticket assembly 10 to be reassembled after being opened.

The game ticket assembly 10 is adaptable for play in different types of lottery games. For example, the game tickets 12, 14 and 16 illustrate different types of winning ticket. The game symbol 38a represents a winning ticket in which the payout is shown on a separate master card. The game symbol 38b indicates a ticket that qualifies the purchaser for participation in a seal prize round. The game symbol 38c indicates an instant winner. The serial number is printed on each game ticket 10, 12, 14 and enables the purchaser to redeem one game ticket while retaining others for a later round of game play. The lottery games themselves are conventional and do not form a part of this invention.

In variant embodiments of the assembly 10, the glue lines on the game tickets are eliminated. The flap interconnecting the top and bottom game tickets is relied upon to maintain the game tickets in their stacked arrangement. In yet other variant embodiments the flap is removed and replaced with a band that surrounds the stack and maintains the game tickets in their stacked arrangement.

FIG. 6 illustrates a second embodiment game ticket assembly 110 in accordance with the present invention. The game ticket assembly 110 is similar to the game assembly 10 but includes four game tickets arranged in a stack: bottom game ticket 112, top game ticket 114, and intermediate game tickets 116 and 118. A fold 120, like to the fold 32a, joins the bottom and top game tickets 112, 114. A flap 122, like the flap 18, extends from the bottom game ticket 112 and adheres to the game ticket.

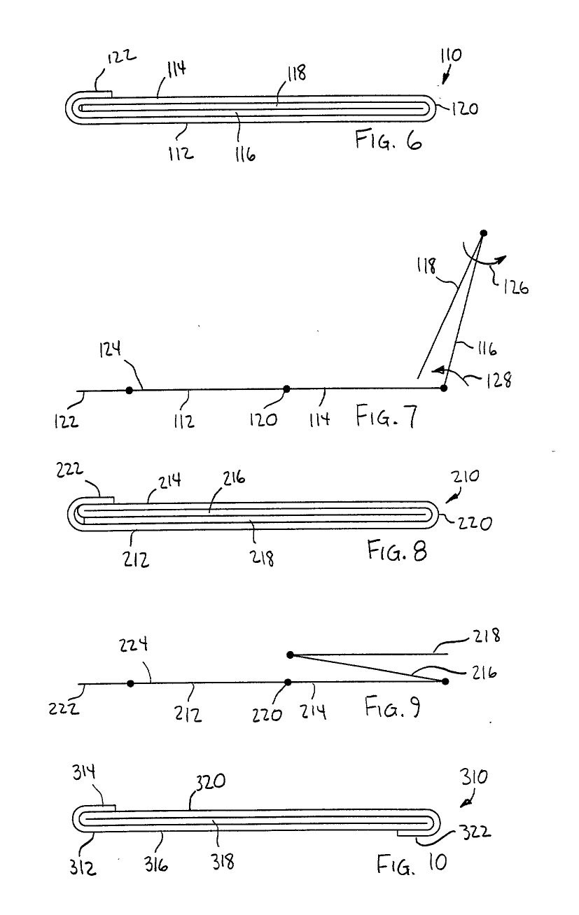

The game ticket assembly 110 is formed from an elongate strip of material 124 (see FIG. 7). FIG. 7 schematically illustrates folding the game tickets 112-118 to form the stack. The game tickets are folded such that the game ticket 112 adjacent the flap 122 is on the bottom of the stack and the game ticket 114 adjacent the game ticket 112 is on top of the stack. This ensures the fold 120 joining the edges of the game tickets 112, 114 extends along the side of the stack and cooperates with the flap 122 to contain the ends of the game tickets as previously described.

In this embodiment the stack is formed by sequentially folding the game tickets on one another, starting with the game ticket 118 on the free end of the strip 124. The game ticket 118 is folded over and above the upper face of the adjacent game ticket 116 as indicated by the arrow 126. The two game tickets 116, 118 are then folded over and above the upper face of the adjacent game ticket 114 as indicated by the arrow 128. The folded game tickets are then folded over and above the upper face of the bottom game ticket 112 to form the stack. The fold 120 will join the bottom and top game tickets 112, 114 regardless of the number of intermediate game tickets spaced along the strip 124.

FIG. 8 illustrates a third embodiment game ticket assembly 210 in accordance with the present invention. The assembly 210 is similar to the assembly 110 and includes bottom game ticket 212, top game ticket 214 and intermediate game tickets 216, 218. The fold 220 and the flap 222 are like the fold 120 and flap 122.

The game ticket assembly is formed from a strip 224 like strip 124 (see FIG. 9). In this embodiment the intermediate game tickets 216, 218 are Z-folded or accordian-folded onto the upper face of the game ticket 214. The game ticket 214 and the Z-folded sheets 216, 218 are then folded over and above the upper face of the game ticket 212. This ensures that the fold 220 will join the bottom and top game tickets 212, 214 regardless of the number of intermediate game tickets spaced along the strip 224.

FIG. 10 illustrates a fourth embodiment game ticket assembly 310 in accordance with the present invention. The assembly 310 is formed from a continuous strip of material 312 including a flap 314 and game tickets 316, 318 and 320 spaced along the strip. The game ticket 316 is adjacent the flap 314 and the game ticket 318 is between the game tickets 316 and 320. In this embodiment the game tickets 314 and 316 are Z-folded above the top surface of the bottom game ticket 312. Unlike the previous embodiments, the game ticket 318 adjacent the bottom game ticket 316 along the strip 312 is not on the top of the stack.

The strip 312 includes a second flap 322 located on the opposite end of the strip 312 from the flap 314. The second flap 322 extends from the top game ticket 316 and overlaps the bottom game ticket 316. The flaps 312, 322 contain the ends of the game tickets and resist riffling of the tickets in the stack as previously described. Either flap 314 or 322 can be flipped or opened to unfold the game tickets.

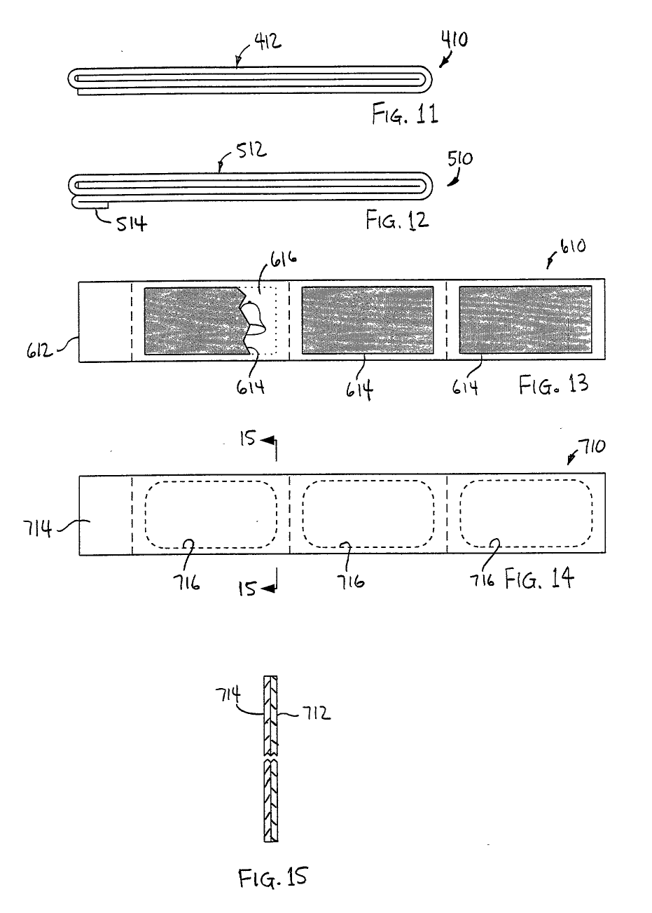

FIG. 11 illustrates a fifth embodiment game ticket assembly 410 in accordance with the present invention. The assembly 410 includes a game ticket stack 412 and is otherwise identical to the game assembly 110, but does not include a flap connecting the top and bottom game tickets in the stack. Instead, the glue on the game tickets operatively connects the top and bottom game tickets to maintain the game tickets in a stacked arrangement.

FIG. 12 illustrates a sixth embodiment game ticket assembly 510 in accordance with the present invention. The assembly 510 includes a game ticket stack 512 and is otherwise identical to the game assembly 410, but includes a pull tab 514 extending from the bottom game ticket. The pull tab facilitates unfolding the stack of game tickets. Preferably the pull tab 514 normally adheres to the bottom game ticket as shown.

FIG. 13 illustrates a seventh embodiment game ticket assembly 610 in accordance with the present invention. The assembly 610 is shown prior to folding a material strip 612 that is identical to the strip 20. Conventional scratch-off coatings 614 cover the game symbol areas 616 and hide the game symbols from view. In this embodiment the glue is placed only on the flap and not on the game tickets. The scratch-off coatings conceal the game symbols even if the sides of the stack are compressed to view the faces of the tickets.

FIGS. 14 and 15 illustrate an eighth embodiment game ticket assembly 710 in accordance with the present invention. The assembly 710 is shown prior to folding and includes a material strip 712 that is identical to the strip 610. Covering the top face of the strip 712 is a material strip 714 that includes break-open window panels 716 over the game symbol areas. The strips 712, 714 form a laminated strip that is folded to form the game ticket assembly 710. The window panels 716 conceal the game symbols even if the sides of the stack are compressed to view the faces of the tickets.

Each of the disclosed embodiments includes a stack of game tickets formed from a continuous strip of material. The number of game tickets in other embodiments of the present invention can vary from those shown, but typically would include three to five game tickets.

While I have illustrated and described preferred embodiments of my invention, it is understood that these are capable of modification, and I therefore do not wish to be limited to the precise details set forth, but desire to avail myself of such changes and alterations as fall within the purview of the following claims.

What I claim as my invention is:

1. A game ticket assembly comprising:
a plurality of game tickets, the game tickets arranged in a stack and comprising a top game ticket on top of the stack and a bottom game ticket on the bottom of the stack;
a breakable connection joining the top and bottom game tickets to retain the game tickets in their stacked configuration until a purchaser breaks the connection; and
the game tickets formed from a continuous length of material comprising one or more folds spaced along the material, each fold joining edges of respective pairs of game tickets, the game tickets displaceable about the folds from a folded position on the stack to an unfolded position when the connection is broken for game play.

2. The game ticket assembly of claim 1 wherein the material comprises first and second faces and each game ticket comprises a game symbol area on the first face.

3. The game ticket assembly of claim 1 wherein one of the folds joins the top and bottom game tickets of the stack.

4. The game ticket assembly of claim 3 wherein the top and bottom game tickets each comprise a game symbol area, and each game symbol area faces the interior of the stack.

5. The game ticket assembly of claim 3 wherein the plurality of game tickets comprises one or more intermediate game tickets stacked between the top and bottom game tickets.

6. The game ticket assembly of claim 1 wherein the plurality of game tickets include one or more intermediate game tickets stacked between the top and bottom game tickets.

7. The game ticket assembly of claim 1 wherein each game ticket comprises a serial number area.

8. The game ticket assembly of claim 7 wherein the material comprises first and second faces, each game ticket comprises a game symbol area on the first face and its serial number area on the second face.

9. The game ticket assembly of claim 1 wherein the breakable connection comprises a flap extending from the bottom game ticket and at least partially overlapping the top of the stack, the flap overlap attached to the top game ticket.

10. The game ticket assembly of claim 9 wherein the breakable connection comprises an adhesive between the flap overlap and the top game ticket.

11. The game ticket assembly of claim 9 wherein the plurality of game tickets comprises one or more intermediate game tickets stacked between the top and bottom game tickets;
the folds adjacent the intermediate tickets are located on first and second sides of the stack; and
the flap extends along one side of the stack and the fold joining the top and bottom game tickets extends along the other side of the stack.

12. The game ticket assembly of claim 11 further comprising an additional flap formed from the material and extending from the top game ticket and at least partially overlapping the bottom of the stack, the additional flap overlap attached to the bottom game ticket.

13. The game ticket assembly of claim 1 wherein the releasable connection comprises an adhesive on each game ticket, the adhesive adhering to the adjacent upper or lower game ticket on the stack.

14. The game ticket assembly of claim 1 comprising a pull tab extending from the top or bottom game ticket to facilitate breaking the breakable connection.

15. The game ticket assembly of claim 1 wherein at least one of the game tickets comprises a game symbol area and a removable layer over the game symbol area and obstructing view of the game symbol area.

16. The game ticket assembly of claim 15 wherein the removable layer comprises a break-open window or a scratch-off coating.

17. The game ticket assembly of claim 1 wherein the breakable connection comprises a band surrounding the stack.

18. A method of manufacturing a game ticket assembly comprising the steps of:
(a) providing a continuous strip of material, the strip of material comprising a plurality of game ticket sections spaced along the length of the strip;
(b) printing a plurality of game indicia on the game ticket sections, each game indicia on a respective game ticket section, the game indicia representing at least one of a label, a serial number and a game symbol;
(c) folding the strip of material along a set of fold lines, each fold line located between pairs of adjacent game ticket sections, and positioning the game ticket sections overlying each other to form a stack of game tickets; and
(d) providing a releasable connection joining the game ticket on top of the stack with the game ticket on the bottom of the stack to retain the game tickets in their stacked arrangement,
whereby releasing the connection enables the game tickets to be unfolded from the stack for game play.

19. The method of claim 18 wherein the game ticket section comprises adjacent first and second game ticket sections, and the step of folding and positioning the game ticket sections comprises the step of positioning the first game section on the bottom of the stack and the second game ticket section on top of the stack.

20. The method of claim 18 wherein the strip of material comprises a flap section and an additional fold between the flap section and the game ticket section, and the step of connecting the top and bottom game tickets comprises folding the flap section along the additional fold line and attaching the flap section to the game ticket on top of the stack.

21. The method of claim 20 wherein the providing step comprises the step of providing a sheet of the material;
the printing step comprises the step of printing the game indicia on the sheet; and
the providing step further comprises the step of separating the material strip from the remainder of the sheet.
